(19) United States
(12) Patent Application Publication
(10) Pub. No.: US 2004/0213003 A1
(43) Pub. Date: Oct. 28, 2004

(54) Suspended ceiling lighting system incorporating T-bar component

(76) Inventors: Bruce Lauderdale, Joplin, MO (US); Paul Eckels, Joplin, MO (US); Mark Williams, Carthage, MO (US)

Correspondence Address: Beirne, Maynard & Parsons, L.L.P., Ste. 2500, 1300 Post Oak Blvd., Houston, TX, 77056-3000, US

(21) Appl. No.: 10/422,441

(22) Filed: Apr. 23, 2003

(51) Int. Cl. F21S 8/06

(52) U.S. Cl. 362/404

(57) ABSTRACT

Suspended ceilings of buildings incorporate a T-bar component which is used to provide an integral lighting system. The T-bar component serves as the backbone or a housing member of the lighting fixture as well as an integral part of the suspended ceiling framework.

### BACKGROUND OF THE INVENTION

(1) Field of the Invention

The invention relates to the use of a T-bar which is an integral part of the lighting fixture as well as an integral part of the suspended ceiling system for a building or the like.

(2) Brief Description of the Prior Art

A suspended ceiling is one which is not directly fixed to the floor or roof structure above it, but, as its name implies, is suspended by means of metal rods and channels which, in turn, are secured to the roof structure by means of a plurality of guide wires. This type of system is most commonly used in commercial/industrial buildings and is sometimes also found in residential construction. Generally speaking, there are three types of suspended ceilings: jointless or flush-finish; modular panel; and strip panel.

A jointless system is simply the suspended ceiling frame with plaster board or gyp rock secured into the furring channels which are connected and supported by top-cross rails, or T-bars. This system can be altered depending on how many layers of sheeting are provided. The more layers that are placed, the more fire-resistant the system will become.

The modular panel system has the suspension clips and main runners that are spaced at intervals with cross-runners or T-bars at the same level to provide a grid that modular tiles may be laid into. Most common materials for this system are gypsum board panels, mineral fiber boards, and plastic acoustic tiles.

The strip panel system consists of narrow strips of pre-formed metal fixed to horizontal carrier rails or T-bars. These panels are then clipped onto the carrier rail and finished with insulation over the top.

The present invention contemplates use in these, as well as other known suspended ceilings commonly in commercial use.

Applicant is aware of the following prior references developed in a pre-filing search:

| U.S. Pat. No. | Inventor(s) |
|---|---|
| 2,888,113 | Schwartz, et al. |
| 3,001,001 | Bibb |
| 3,504,172 | Lieberman |
| 4,230,297 | Comer, et al. |
| 4,414,617 | Galindo |
| 5,085,392 | Perna |

None of the prior art references cited above discloses the incorporation component of a suspended ceiling as an integral component of a lighting fixture system. For example, the '392 patent discloses an apparatus for securing an electrical appliance through the ceiling board itself which is disposed between crossing T-bar members.

The '297 patent provides a securing system whereby the upper face of a T-bar can be used to attach a device protruding through the lighting fixture housing for securement thereof. The securement device does not form part of the housing, which is only inserted therethrough.

The '113 patent discloses a fluorescent light tube system formed by a channel member, referred to as “13”, which is traversed at spaced integrals by a series of T-bars 12.

The '172 patent is a similar disclosure with a ceiling wiring channel for a series of lights 15.

The '001 patent discloses a light fixture for suspended grid ceiling which is suspended on one side of a channel member above a T-bar component. The housing, including member 62, is suspended below the lower face of the T-bar member.

The '617 patent incorporates the use of a T-bar, such as 36, as part of the housing for a wire system for a track lighting system. The T-bar 36 is not an integral part of the housing for the track light and only serves to carry the electrical conduits in association with the light.

### SUMMARY OF THE INVENTION

The present invention provides a lighting fixture incorporating a T-bar component for a suspended ceiling lighting system. The lighting fixture comprises a housing including a T-bar component. Electric light emitting bulb means, such as incandescent, fluorescent, light-emitting diodes (LEDs), and the like, are carried within the housing. Reflector and/or refractor means may be provided which are carried by the housing, for redirecting light emitted by the bulb means in at least one direction away from the lighting fixture.

As used in the specification and in the claims, “reflector” means: a device used to redirect the light from a lamp or luminaire by the process of reflection. “Refractor” means: a device used to redirect the light flow from a source, primarily by bending the waves of light.

### BRIEF DESCRIPTION OF THE DRAWINGS

FIG. 1 is a perspective view of a typical suspended ceiling of the present invention.

FIG. 2 is a view similar to that of FIG. 1 taken just above a suspended ceiling system for incorporating the present invention.

FIG. 3A is an exterior illustration of one embodiment of the present invention prior to incorporation within a suspended ceiling system.

FIG. 3B is a perspective illustration of the lighting fixture of the present invention incorporated within a typical suspended ceiling system.

FIG. 3C is a detailed perspective view of the components the lighting fixture system of 3A.

FIG. 3D is a cross-sectional view along lines D-D of FIG. 3C.

FIG. 4A is a cross-sectional, end-perspective view of another embodiment of the lighting fixture of the present invention mounted in the suspended ceiling system.

FIG. 4B is an enlarged, detailed view of a lighting fixture and system of FIG. 4A.

FIG. 4C is an isometric view of a lighting fixture of the present invention as shown in FIGS. 4A and 4B.

FIG. 5A is a schematic illustration of a lighting fixture of the present invention incorporating light-emitting diodes.

FIG. 5B is a cross-sectional view taken along line 5B-5B of FIG. 5A.

FIG. 6A is an isometric view of yet another embodiment of the lighting fixture of the present invention.

FIG. 6B is a sectional view taken along line 6B-6B of FIG. 6A.

FIG. 6C is a bottom, isometric view, looking upwardly, of the lighting fixture embodiment of FIGS. 6A and 6B.

FIG. 7 is a perspective illustration incorporating track lighting into the suspended-ceiling lighting system of the present invention.

FIG. 8A is an alternative embodiment of the present invention incorporating light-emitting diodes.

FIG. 8B is a cross-sectional view taken along line 8B-8B of FIG. 8A.

FIG. 9A is yet another illustration of an alternate, light-emitting diode design fixture incorporating the present invention.

FIG. 9B is a cross-sectional view taken along line 9B-9B of FIG. 9A.

FIG. 10A is a perspective view of the component parts of yet another alternative embodiment of the present invention incorporating light-emitting diodes.

Figure 10B is a cross-sectional view taken along line 10B-10B of Figure 10A.

FIG. 11A is a perspective illustration of yet another embodiment of the present invention incorporating both a light reflector and a light refractor.

FIG. 11B is a cross-sectional view of the embodiment of FIG. 11A, taken along line 11B-11B of FIG. 11A.

### DESCRIPTION OF THE PREFERRED EMBODIMENTS

First referring to FIG. 1, there is shown, in general, a suspended ceiling system (SCS), having a series of light fixtures (LF) incorporated therein.

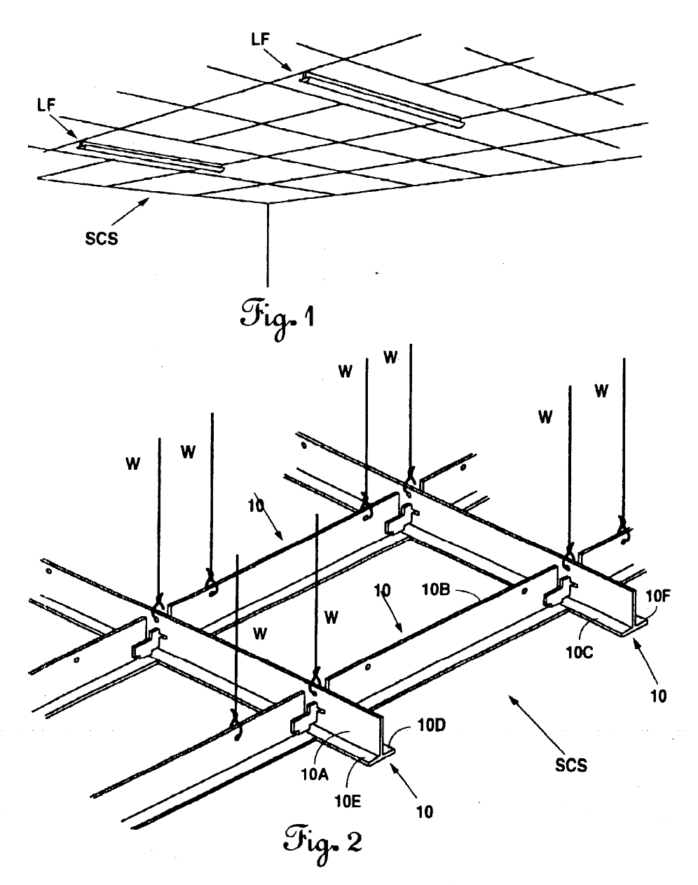

The suspended ceiling system (SCS) is shown in more detail in FIG. 2, in which a series of T-bars 10 shown cross-positioned at 90-degree intervals form the system SCS which is suspended from the lower face a permanent ceiling (not shown) by means of metal or other wires ore suspending means W. Typically, each of the T-bars 10 will have a vertical member 10A which has an upper face 10B and a lower face 10C. Positioned at a 90-degree offset relative to the vertical member 10A and secured to the face 10C is a vertically similar T-bar member 10D having upwardly-facing surfaces 10E and 10F.

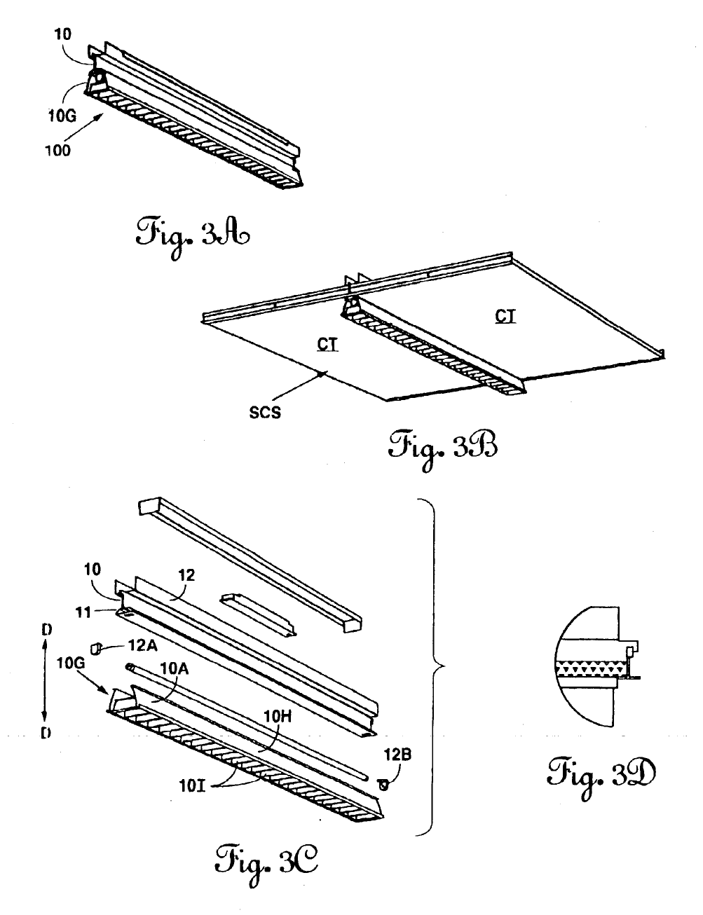

Now referring to FIG. 3A, the typical apparatus 100 of the present invention will include T-Bar 10 as an integral component of the housing 11 which in the embodiment as shown in FIGS. 3A, 3B and 3C consists of T-bar 10 a refractor or shielding 10A carried by the T-bar 10 along upper shoulders or faces 10 E and 10 F. (FIG. 2). Channel member 12 is secured on the upper face 10B (FIG. 2) of the T-bar member 10 for carriage of ballast, wires, and the like, utilized in the particular lighting fixture 100.

As shown in FIG. 3B, the suspended ceiling lighting system (SCS) is carried on the T-bar 10 such that the louver shielding and housing components below the T-bar number 10 project below ceiling tiles (CT) which may also be carried within the system SCS from the shoulders or surfaces 10E and 10F (FIG. 2) of the T-bars 10.

As shown in FIG. 3C, the housing 11 of the suspended ceiling system (SCS) consists of a T-bar 10 to which is mounted a fluorescent or other bulb means 12C therein having sockets 12A and 12B of known design and configuration at each end thereof. Housing 11 also includes a shielding louvered system 10A having angled side or other walls 10G and 10H a series of elongated cross-louvers 101 at various lengths along the members 10G and 10H for directing light generated by the fluorescent or other bulb means 12C away from the suspended ceiling system (SCS).

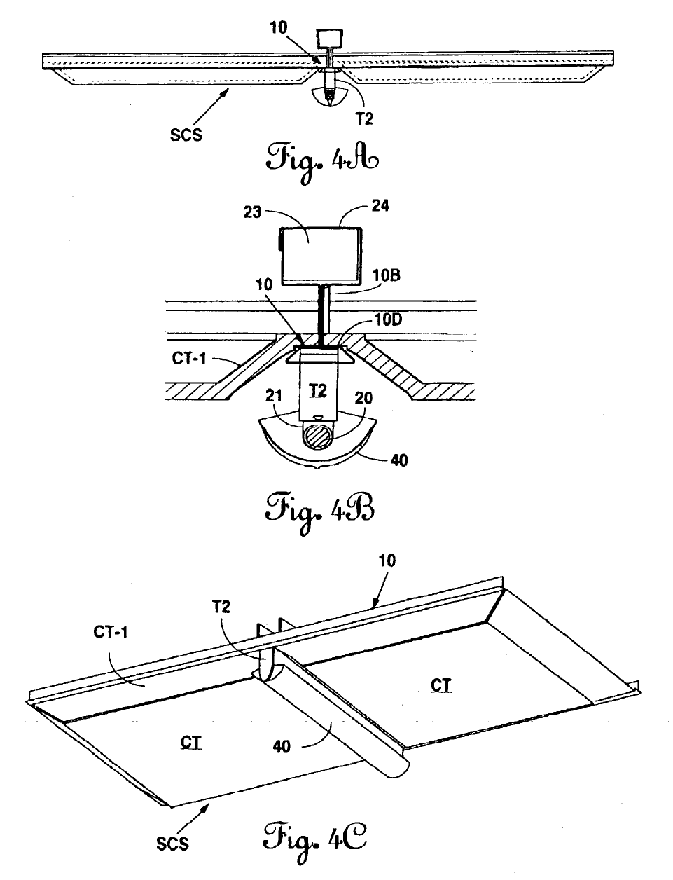

Now referring to FIGS. 4A, 4B and 4C, there is shown an alternative embodiment of the present invention in which the T-bar member 10 actually serves as the upper housing member in the suspended ceiling system (SCS). In this configuration, a fluorescent light bulb 20 is disposed within a lamp socket 21 with end members T2 forming part of the housing secured to the lower face 10D of the T-bar 10. A ballast compartment 23 a selectively openable by a cover or flat 24 which may be carried on the upper-most surface 10B of T-bar 10. The suspended ceiling system (SCS) also includes ceiling tiles (CT) which have a bevel CT-1, such as that shown in FIGS. 4B and 4C and which functions as an indirect lighting reflector for light emitted from the bulb 20. A primary reflective fuser shielding 40 is also carried by ends 12 such that light first directed toward surfaces CT1 of the tiles CT is then secondarily fused or directed to and toward a floor or wall in the room.

Now referring to FIGS. 5A and 5B, the suspended ceiling system (SCS) of the present invention may incorporate a series of light-emitting diodes 30 which are carried on lower face 10C of the T-bar number 10 within a refractor assembly 31. A driver compartment 32, a LED driver 33, of known construction, and cover 34 may be positioned on the upper surface 10B of the T-bar 10.

It will be appreciated that the invention herein is not limited to the use of incandescent, fluorescent or other “bulbs”, but may also be used with any electro-luminescent materials, solar enabled panels or the like, all referred to herein collectively as simply “bulbs”.

Now referring to FIGS. 6A and 6C, there is shown in FIG. 6A a suspended ceiling system SCS which also includes luminous panels CT which may be made from transparent material with either prismatic facets or a reflective top layer or which may be silk screened to reflect light downward into the room.

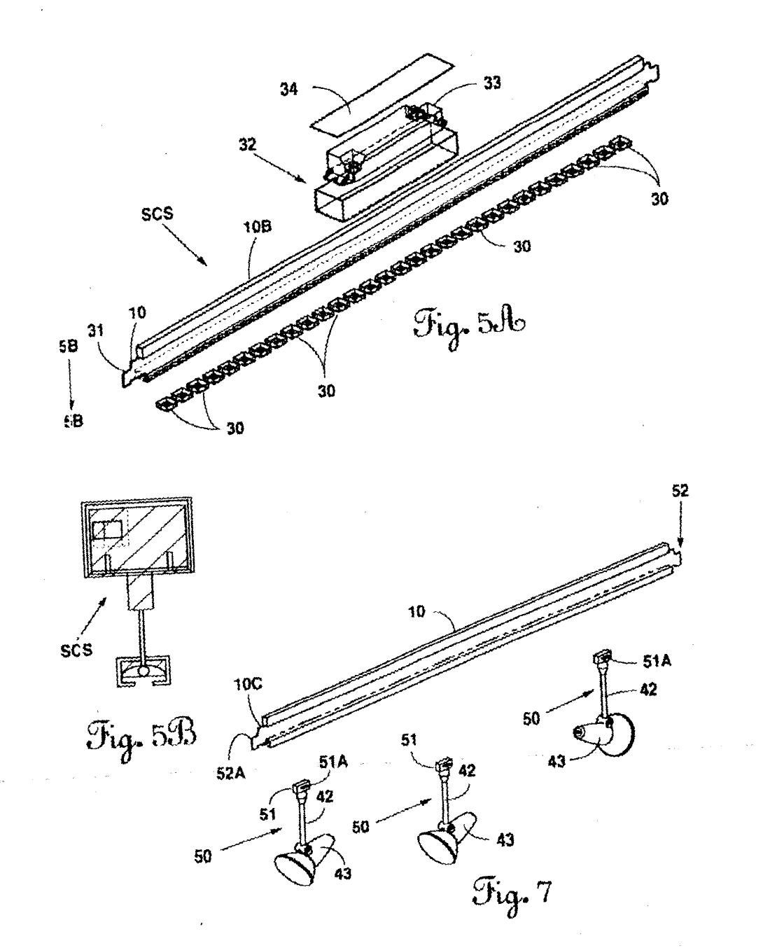

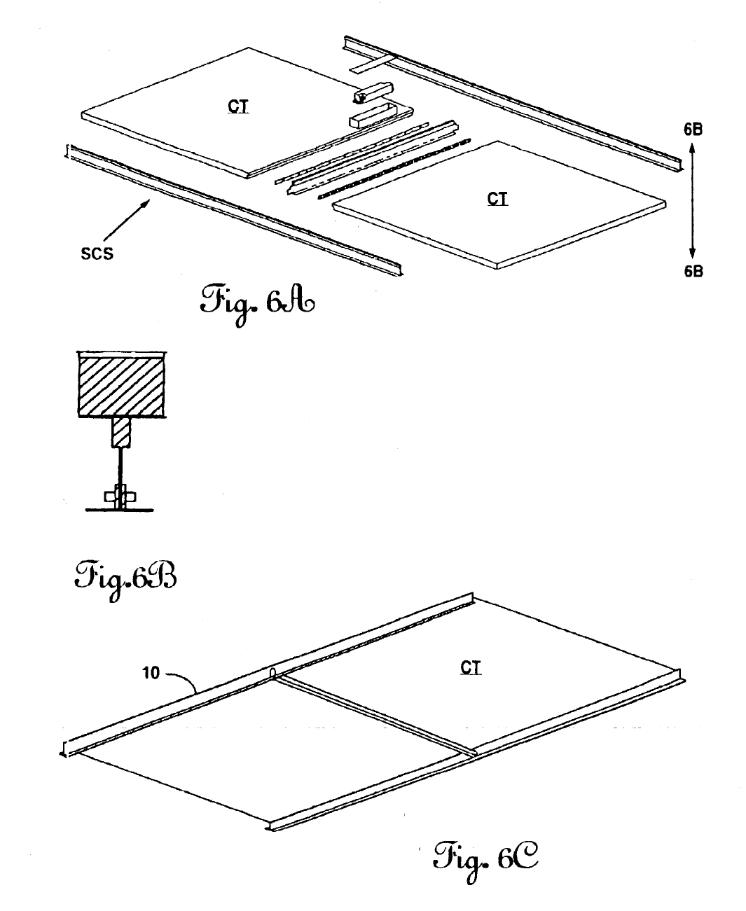

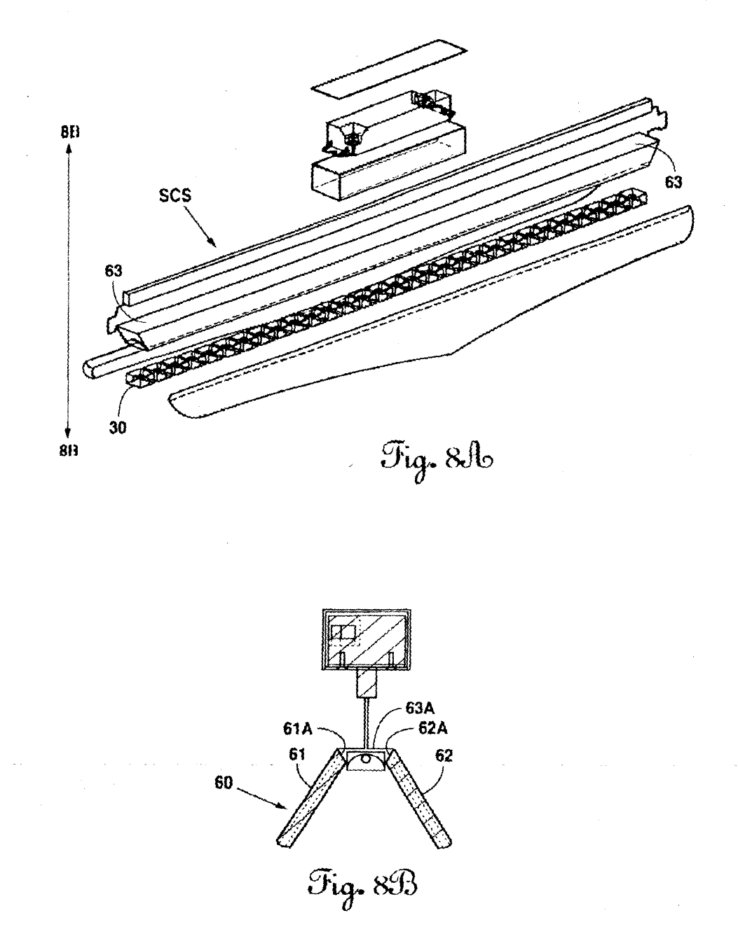

Now referring to FIG. 7, the present invention may incorporate a series of track light elements 50 having a head 51 carrying an extension 42, and a pivotable light housing assembly 43 at lower-most end thereof. A lighting track 52 having side walls 52A and 52B secures track lights 50 as prongs 51A are compressed slightly into place to snap in or other known positioning means. The prongs 51Atypically will be spring-biased to urge them to an outwardly-extended position, but may be selectively compressed, just slightly, to be received within the track walls 52A and 52B. The walls 52A and 52B are joined at their top center or otherwise configured or welded or otherwise joined to the lower face 10C of the T-bar member 10.

Now referring to FIGS. 8A and 8B, yet another suspended ceiling system SCS illustrated with light-emitting diodes 30 and shielding system 60 with side shields 61 and 62 (FIG. 8B). Each of the shields 61 and 62 having an end 61A and 62A joining the outer housing 63 of the light-emitting diode components 30. The diodes 30 are carried within their housing 63 which has an upper surface 63A which, in effect at the horizontal lower T-member face 10C.

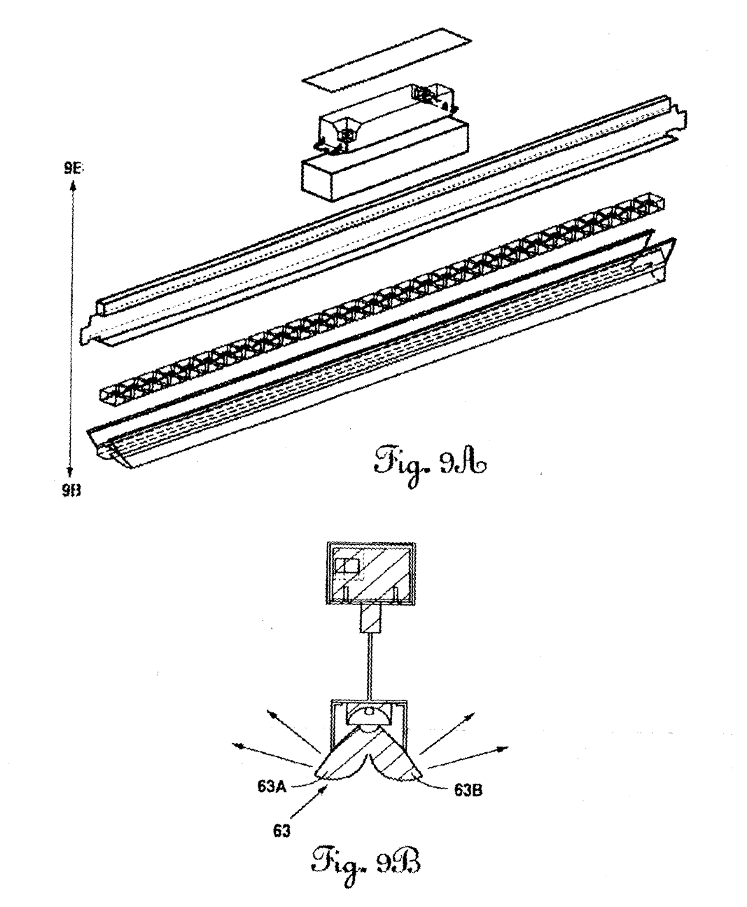

Now referring to FIGS. 9A and 9B, there is shown a similar system as that shown in FIGS. 8A and 8B with a petal-like light refractor 63 to guide and control the light instead of the refractor elements previously described. Such a configuration works in the manner of a headlight or eyeglasses to control the light direction and intensity. As shown, the refractor is intended to direct the light onto adjacent ceiling tiles for an indirect lighting effect by use of petal members 63A and 63B.

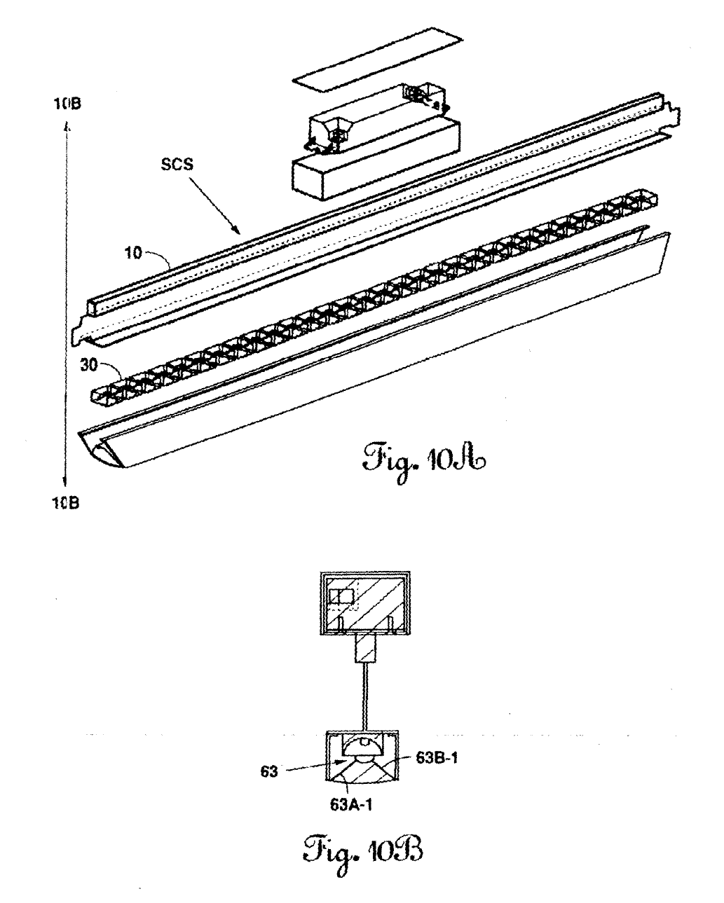

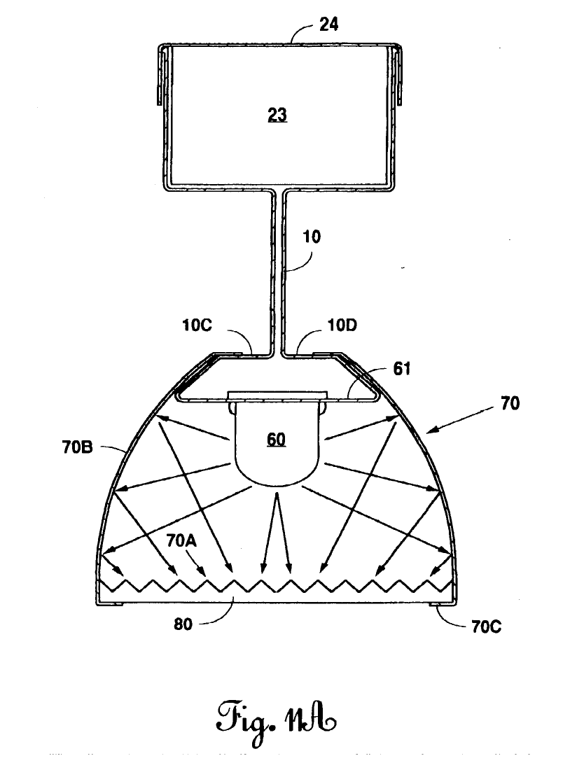

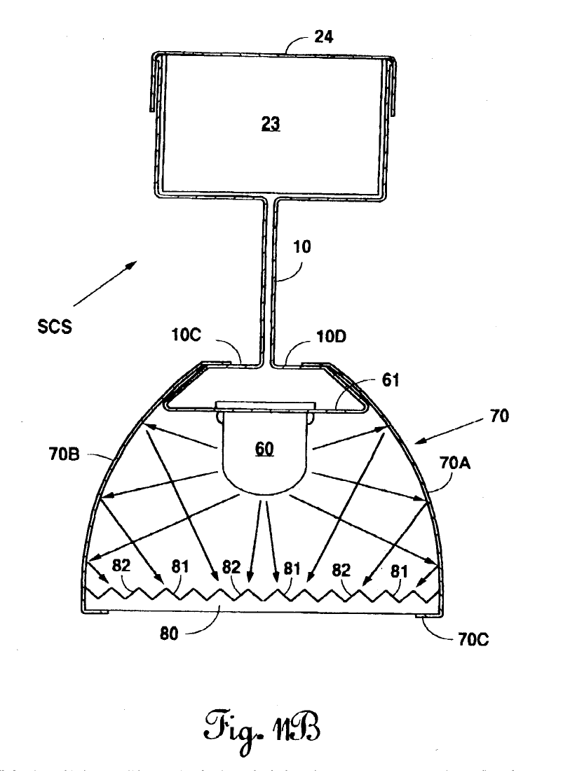

Yet another embodiment of the present invention is shown in Figures 10A and 10B, in which the light refractor 63 has outer walls 63B-1 and 63B-1 offset a straight 45-degree angle for reflective purposes. It will be appreciated that the angle of surfaces 63B-1, 63B-1 or contour or configuration is a matter of design choice. This is a refractor that is intended to direct the light downwardly.

Now turning to FIGS. 11A and 11B, there is shown yet another embodiment of the present invention in which suspended ceiling system SCS takes the form of a T-bar member 10. The lighting fixture 100 has a reflector 70 having reflector members 70A and 70B to direct light to a refractor 80 which has oppositely angled surfaces 81 and 82 disposed to direct lighting downward into the room. The refractor is housed along a circular internal shoulder 70C of the reflector 70 which, in turn, is secured at its upper end to the upwardly facing shoulders or surfaces 10C and 10D of T-bar member 10.

Although the invention has been described in terms of specified embodiments which are set forth in detail, it should be understood that this is by illustration only that the invention is not necessarily limited thereto, since alternative embodiments and operating techniques will become apparent to those skilled in the art in view of the disclosure. Accordingly, modifications are contemplated which can be made without departing from the spirit of the described invention.

What is claimed and desired to be secured by Letters Patent is:

1) A lighting fixture incorporating a T-bar component for a suspended ceiling lighting system, comprising:
(a) a housing, including a T-bar component;
(b) electric light emitting bulb means carried within said housing; and
(c) reflector means carried by said housing for directing light emitted by said bulb beams in at least one direction away from said bulb means.

2) The lighting fixture of claim One, wherein said light-emitting bulb means includes at least one fluorescent bulb.

3) The lighting fixture of claim One, further comprising ballast means disposed within said T-bar.

4) A lighting fixture of claim Two, further comprising ballast means disposed within said T-bar.

5) A lighting fixture incorporating a T-bar component for a suspended ceiling lighting system, comprising:
(a) a housing, including a T-bar component;
(b) electric light emitting bulb means carried within said housing;
(c) reflector means extending from said housing;
(d) a primary reflector panel, selectively, pivotably, secured to said housing to direct light emitted from said bulb in the direction of said ceiling; and
(e) Secondary refractor means including a plurality of ceiling tile means proximately disposed in said suspended ceiling and adjacent said primary refractor panel for re-directing light emitted from said bulb means and said primary reflector panel in directions away from said ceiling.

6) A lighting fixture of claim One or claim 2, wherein said bulb means comprises a series of light emitting diodes.

7) A light fixture of claim One or claim 2, wherein the bulb means comprise a series of light emitting diodes; and said refractor means comprises first and second luminous transparent panels, said primary panel being secured on one side of said housing, and the second of said primary panels being secured on another side of said housing, said primary panel having first and second sides, each of said sides defining one, flat, continuous surface there across.

8) The lighting fixture of claim One, wherein the bulb means comprises at least one member of the group consisting of light-emitting diodes, a fluorescent bulb, and an incandescent light bulb.

9) A lighting fixture incorporating a T-bar component for a suspended ceiling lighting system comprising:
(a) a housing, including a T-bar component;
(b) track means carried by said housing for receipt of at least one track light head thereon, and selectively movable thereon.

10) The lighting fixture of claim Nine, further comprising refractor means carried by each of said track light heads and bulb means securable within said track light heads said refractor means, directing light emitted by said bulb means within said track light head, in at least one direction away from said lighting fixture.

11) A lighting fixture incorporating a T-bar component for a suspended ceiling lighting system, comprising:
(a) a housing, including a T-bar component;
(b) electric light emitting bulb means carried within said housing;
(c) reflector means carried by said housing for directing light emitted by said bulb beams in at least one direction away from said bulb means; and
(d) refractor means carried by said housing for directing light emitted by said bulb means in at least one direction away from said bulb means.
